(19) United States
(12) Patent Application Publication
(10) Pub. No.: US 2014/0010746 A1
(43) Pub. Date: Jan. 9, 2014

(54) METHOD AND DEVICE FOR CLEANING THE EXHAUST GAS OF AN INTERNAL COMBUSTION ENGINE

(71) Applicant: Robert Bosch GmbH, Stuttgart (DE)

(72) Inventors: Stefan Scherer, Stuttgart (DE); Rolf-Dieter Koch, Ditzingen (DE)

(21) Appl. No.: 13/935,787

(22) Filed: Jul. 5, 2013

(30) Foreign Application Priority Data
Jul. 5, 2012 (DE) 10 2012 211 684.2

(51) Int. Cl. F01N 3/20; B01D 53/94

(52) U.S. Cl. CPC F01N 3/206; B01D 53/9495
USPC 423/212; 422/111

(57) ABSTRACT

A method for cleaning the exhaust gas of an internal combustion engine, wherein nitrogen oxide in the exhaust gas is converted by means of hydrocarbons metered in a pulsed form into the exhaust gas duct, upstream of a nitrogen oxide catalytic converter.

### BACKGROUND OF THE INVENTION

The invention relates to a method for cleaning the exhaust gas of an internal combustion engine, wherein nitrogen oxide in the exhaust gas is converted by means of hydrocarbons metered in a pulsed form into the exhaust gas duct upstream of a nitrogen oxide catalytic converter.

The invention also relates to a device for cleaning the exhaust gas of an internal combustion engine, wherein a nitrogen oxide catalytic converter is provided for converting nitrogen oxide and wherein a metering device for metering in hydrocarbons in a pulsed form is provided in the exhaust gas duct, upstream of the nitrogen oxide catalytic converter.

Nowadays, various catalytic converters and filters are provided in exhaust gas post-treatment systems in order to reduce emissions of undesired components of the exhaust gas of internal combustion engines. It is therefore possible, for example in diesel engines, to provide not only oxidation catalytic converters for oxidizing hydrocarbons and carbon monoxide but also diesel particle filters and NOx storage catalytic converters.

Particle filters are used to reduce the emission of particles. The exhaust gas is directed through the particle filter which precipitates the solid particles in the exhaust gas and retains them in a filter substrate. As a result of the soot masses embedded in the filter substrate, the particle filter becomes clogged over time, and the embedded mass of soot has to be burnt off from time to time in a regeneration process.

NOx storage catalytic converters (NSC: NOx storage catalytic converter) are used to reduce the nitrogen oxide (NOx) emission of internal combustion engines. During operation of the internal combustion engine, NO₂ is embedded in the NOx storage catalytic converter. NO is oxidized here on the storage catalytic converter itself or in an oxidation catalytic converter arranged upstream to form NO₂. If the NO₂ storage limit of the nitrogen oxide storage catalytic converter is reached, it must be regenerated. In order to make available the carbon monoxide which is necessary for this, the exhaust gas must have a lambda less than or equal to 1. For this purpose, the internal combustion engine must generally be switched over into a regeneration mode, that is to say the motor parameters are changed to a greater or lesser degree in order to reach the exhaust gas composition and exhaust gas temperature necessary for the regeneration. In this context it is to be noted that the operator of the vehicle should not notice any change in the driving behavior as a result of this measure which is necessary in short time intervals of a few minutes. It is also disadvantageous that generally the fuel consumption is increased by such a measure and that the lubrication oil can be thinned. In addition, the operation of the engine can be adjusted in order to set a rich exhaust gas mixture generally only in a part of the operating range of the engine. In the case of diesel engines which are operated upstream in a lean fashion, the injection of fuel into the exhaust gas duct can be provided directly before the NOx storage catalytic converter.

It is also possible to provide for the metering in of fuel to be performed in relatively short intervals of a few seconds. EP 2402571A1 and EP 2402572A1 describe a method for improving the cleaning effect of a NOx catalytic converter at a high operating temperature. The cleaning is carried out here according to two methods. At a high operating temperature, hydrocarbon in the form of fuel is metered into the exhaust gas stream upstream of the NOx catalytic converter in short intervals, and NOx is converted by means of a mechanism which is described there in more detail. The storage method is used at a low catalytic converter operating temperature.

If hydrocarbon in the form of fuel is metered into the exhaust gas stream of an internal combustion engine operated with a lean air/fuel mixture, part of the hydrocarbon is oxidized by the excess oxygen in the exhaust gas and by oxygen which has accumulated in the catalytic converter. Only the remaining quantity of hydrocarbon contributes to the conversion of the NOx. It is therefore advantageous to introduce the hydrocarbon in pulses with the largest possible injection quantity of, for example, 60 to 250 milligrams per pulse in short pulses of, for example, 10 to 60 milliseconds. It is necessary to ensure here that the hydrocarbon can also actually be exploited and not pass unused through the catalytic converter. This would signify an undesired expulsion of materials in the exhaust gas and increased consumption of fuel. The limiting value of the metered quantity which is described in this way is referred to as the slip limit. The slip limit depends here, inter alia, on the temperature of the catalytic converter and on the exhaust gas mass flow.

DE102005049770A1 describes a method for operating an internal combustion engine in whose exhaust gas region, which contains an exhaust gas post-treatment device, a reagent is introduced in predefined operating states of the internal combustion engine and/or of the exhaust gas post-treatment device. The method is characterized in that a correction variable for a reagent signal, which defines the reagent quantity which is to be introduced into the exhaust gas region, is determined, and in that the correction variable is defined on the basis of a comparison of a measure of the actual quantity of the reagent in the exhaust gas region, which quantity has been introduced owing to a measure of a predefined setpoint quantity, and the measure for the setpoint quantity. The document proposes in this respect that the actual quantity be obtained from a lambda value which is determined in the exhaust gas region.

### SUMMARY OF THE INVENTION

The object of the invention is therefore to make available a method for determining a suitable quantity of hydrocarbons being metered into the exhaust gas duct of an internal combustion engine upstream of a nitrogen oxide catalytic converter.

The object of the invention is furthermore to make available a device for carrying out the method.

### Disclosure of the invention

The object of the invention which relates to the method is achieved in that, in the exhaust gas stream downstream of the nitrogen oxide catalytic converter, a concentration or a measure of the concentration of hydrocarbons in the exhaust gas is determined by means of a hydrocarbon sensor, and the metered quantity of the hydrocarbons is influenced on the basis of the concentration of hydrocarbons or the measure of the concentration, which has been determined by means of the hydrocarbon sensor and has passed through the nitrogen oxide catalytic converter, in such a way that a breakthrough of hydrocarbons through the nitrogen oxide catalytic converter is just avoided. If hydrocarbons in the form of fuel are metered into the exhaust gas of an internal combustion engine which is operated with a lean air/fuel mixture, the overstoichiometric oxygen oxidizes a portion of the hydrocarbons and only the remaining part contributes to the reduction of the nitrogen oxides into water vapor, nitrogen and carbon dioxide at the nitrogen oxide catalytic converter. It is therefore advantageous to meter the hydrocarbons in pulses which are as high but also as short as possible.

On the other hand, the metering of fuel must not be so great that appreciable quantities of hydrocarbons remain in the exhaust gas downstream of the nitrogen oxide catalytic converter and exit the system with the exhaust gas stream. Such a breakthrough of hydrocarbons would unnecessarily increase the consumption of the internal combustion engine of fuel and the undesired emissions. It is therefore advantageous to set the metering of the fuel in such a way that the system is operated just below the so-called slip limit at which the metering in of fuel just fails to bring about a breakthrough of hydrocarbons, but the nitrogen oxides are converted as completely as possible. In practice, pulses with a length of 10 to 60 milliseconds with metering of 60 to 250 milligrams of hydrocarbons have proven suitable.

If the metered quantity of hydrocarbons which is introduced in a pulsed form is set in such a way that the hydrocarbon concentration which has passed through the nitrogen oxide catalytic converter or a measure of the hydrocarbon concentration does not exceed a predefined limiting value, a maximum possible efficiency can be achieved during the conversion of nitrogen oxide by means of the metered in fuel. At the same time, regulations relating to permissible emissions of nitrogen oxide and of hydrocarbons can be complied with.

One embodiment of the method provides that a mass flow or a mass of hydrocarbons is used as a measure of the concentration of hydrocarbons. In this way, a predefinable limiting value for hydrocarbons can be complied with in the exhaust gas stream downstream of the nitrogen oxide catalytic converter, with respect to a volume flow of exhaust gas or with respect to an overall quantity.

The regulation for metering in of fuel can be configured in a particularly suitable way by determining the hydrocarbon concentration which passes through per pulse and/or averaged over time over a plurality of pulses. It is therefore possible, on the one hand, to react with very little notice and, on the other hand, brief disruptions can be avoided and long-term trends can be detected and compensated for. The formation of the average over time over a plurality of pulses can be carried out here by forming a sliding average.

One refinement of the method provides that the predefined limiting value is predefined as a function of the catalytic converter temperature and/or the exhaust gas mass flow.

According to the invention there is provision that in a closed loop control circuit the metered quantity is regulated with the nitrogen oxide catalytic converter, the hydrocarbon sensor, an assigned control unit with a regulating logic and a metering unit for hydrocarbons, upstream of the nitrogen oxide catalytic converter. In this way, differences in the metering accuracy, the ageing of the catalytic converter and influences of the temperature and exhaust gas mass flow can be taken into account and compensated for.

If a nitrogen oxide storage catalytic converter is used as a nitrogen oxide catalytic converter, cleaning of the exhaust gas with little use of fuel can be achieved in phases of low nitrogen oxide quantity in the exhaust gas and in a mean temperature range between 200° C. and 450° C.

Diagnosing components of the exhaust gas cleaning system in terms of damage or ageing is possible in that ageing of the catalytic converter is determined from the metered quantity of the hydrocarbons and the quantity of hydrocarbons which have passed through the nitrogen oxide catalytic converter. Removal of individual components from the exhaust gas cleaning system can also be detected in this way.

One development of the method for diagnosing the exhaust gas cleaning system provides that, in addition to measuring the hydrocarbon concentration in order to assess the ageing of the nitrogen oxide catalytic converter, the lambda values of the exhaust gas upstream and downstream of the nitrogen oxide catalytic converter are also taken into account, in order to differentiate changes at the injection device from changes in the behavior of the catalytic converter.

The object of the invention relating to the device is achieved in that a hydrocarbon sensor is provided in the exhaust gas duct downstream of the nitrogen oxide catalytic converter, the output signal of which hydrocarbon sensor is fed to a controller which contains a circuit or a programming sequence for predefining the metering while maintaining an upper limit for a breakthrough of hydrocarbons through the nitrogen oxide catalytic converter. With such a device it is possible to achieve an optimized use of the quantity of fuel with respect to the cleaning effect in the exhaust gas.

One embodiment of the device provides that the hydrocarbon sensor is arranged behind a diesel particle filter (DPF) which is connected downstream of the nitrogen oxide catalytic converter.

### BRIEF DESCRIPTION OF THE DRAWINGS

The invention will be explained in more detail below with reference to an exemplary embodiment which is illustrated in the figures. In the drawing:

FIG. 1 shows an internal combustion engine with an exhaust gas cleaning system, and

FIG. 2 shows a time profile of a concentration of hydrocarbons.

### DETAILED DESCRIPTION

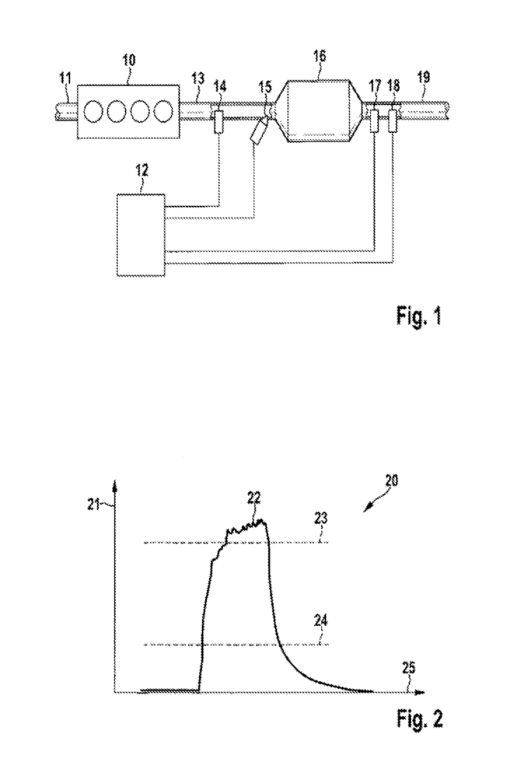

FIG. 1 shows an internal combustion engine 10 with an air supply 11 and an exhaust gas duct 13. Exhaust gas from the internal combustion engine 10 is cleaned of nitrogen oxide in the exhaust gas duct 13 by means of a nitrogen oxide catalytic converter 16 with an integrated diesel particle filter in that hydrocarbons are metered in a pulsed form into the exhaust gas by means of a metering unit 15. Said hydrocarbons are converted with the nitrogen oxide in the nitrogen oxide catalytic converter 16 catalytically to form water vapor, carbon dioxide and nitrogen which are led out via an exhaust gas outlet 19. However, the invention cannot also be applied to systems without a diesel particle filter. A control unit 12 is connected to the metering unit 15 and to a hydrocarbon sensor 17. By means of the output signal of the hydrocarbon sensor 17, the metered quantity which is introduced by the metering unit 15 is regulated by means of the programming sequence in the control unit 12 in such a way that a breakthrough of hydrocarbons downstream of the nitrogen oxide catalytic converter 16 is just avoided. Furthermore, the output signals of a first gas sensor 14 and of a second gas sensor 18 are fed to the control unit 12 and are used to determine the lambda value of the exhaust gas upstream and downstream of the nitrogen oxide catalytic converter 16, with the result that the air/fuel mixture which is fed to the internal combustion engine 10 can be set in accordance with the requirements of the operation. The output signals of the first and second gas sensors 14, 18 are also used in the evaluation of ageing of the nitrogen oxide catalytic converter 16.

FIG. 2 shows a timing diagram 20 of a pulse-shaped profile of a concentration of hydrocarbons during the metering into the exhaust gas duct 13. A concentration profile 22 in a pulsed form is shown along a time axis 25 and a concentration axis 21. Furthermore, a first limit 23 and a second limit 24 are shown. If the internal combustion engine 10 is supplied with a lean air/fuel mixture and hydrocarbons are metered into the exhaust gas duct, some of the hydrocarbons are firstly oxidized by the oxygen which is present in over-stoichiometric amounts. This is indicated in the timing diagram by the second limit 24 below which the quantity of hydrocarbons which are oxidized in this way lies. Concentration values above this contribute to the conversion of nitrogen oxides. It is therefore advantageous to meter in in a pulsed form with sufficiently high concentrations. If the concentration profile 22 exceeds the first limit 23, the total quantity of hydrocarbons in the nitrogen oxide catalytic converter 16 can no longer be converted in the time available and a breakthrough of hydrocarbons occurs. Slipping of hydrocarbons with respect to the quantity metered in with the metering unit 15 therefore occurs, and said slipping has to be avoided since it increases the consumption of the internal combustion engine and the emissions thereof. Therefore, only the hydrocarbon in the concentration range between the second limit 24 and the first limit 23 is effective in the conversion of nitrogen oxide.

What is claimed is:

1. A method for cleaning exhaust gas of an internal combustion engine (10), wherein nitrogen oxide in the exhaust gas is converted by hydrocarbons metered in a pulsed form into an exhaust gas duct (13), upstream of a nitrogen oxide catalytic converter (16), characterized in that in the exhaust gas stream downstream of the nitrogen oxide catalytic converter (16) a concentration or a measure of the concentration of hydrocarbons in the exhaust gas is determined by a hydrocarbon sensor (17), and the metered quantity of the hydrocarbons is influenced on the basis of the concentration of hydrocarbons or the measure of the concentration, which has been determined by the hydrocarbon sensor (17) and has passed through the nitrogen oxide catalytic converter (16), in such a way that a breakthrough of hydrocarbons through the nitrogen oxide catalytic converter (16) is just avoided.

2. The method according to claim 1, characterized in that the metered quantity of hydrocarbons which is introduced in a pulsed form is set in such a way that the hydrocarbon concentration which has passed through the nitrogen oxide catalytic converter (16) or a measure of the hydrocarbon concentration does not exceed a predefined limiting value.

3. The method according to claim 1, characterized in that a mass flow or a mass of hydrocarbons is used as a measure of the concentration of hydrocarbons.

4. The method according to claim 1, characterized in that the hydrocarbon concentration which passes through is determined per pulse and/or averaged over time over a plurality of pulses.

5. The method according to claim 2, characterized in that the predefined limiting value is predefined as a function of the catalytic converter temperature and/or the exhaust gas mass flow.

6. The method according to claim 1, characterized in that in a closed loop control circuit the metered quantity is regulated with the nitrogen oxide catalytic converter (16), the hydrocarbon sensor (17), an assigned control unit (12) with a regulating logic and a metering unit (15) for hydrocarbons, upstream of the nitrogen oxide catalytic converter (16).

7. The method according to claim 1, characterized in that a nitrogen oxide storage catalytic converter is used as a nitrogen oxide catalytic converter (16).

8. The method according to claim 1, characterized in that ageing of the nitrogen oxide catalytic converter (16) is determined from the metered quantity of the hydrocarbons and the quantity of hydrocarbons which have passed through the nitrogen oxide catalytic converter (16).

9. The method according to claim 1, characterized in that, in addition to measuring the hydrocarbon concentration in order to assess the ageing of the nitrogen oxide catalytic converter (16), lambda values of the exhaust gas upstream and downstream of the nitrogen oxide catalytic converter (16) are also taken into account.

10. A device for cleaning the exhaust gas of an internal combustion engine (10), wherein a nitrogen oxide catalytic converter (16) is provided for converting nitrogen oxide, and wherein a metering unit (15) for metering hydrocarbons in a pulsed form is provided in an exhaust gas duct (13), upstream of the nitrogen oxide catalytic converter (16), characterized in that a hydrocarbon sensor (17) is provided in the exhaust gas duct (13) downstream of the nitrogen oxide catalytic converter (16), an output signal of which hydrocarbon sensor (17) is fed to a controller (12) which contains a circuit or a programming sequence for predefining the metering while maintaining an upper limit for a breakthrough of hydrocarbons through the nitrogen oxide catalytic converter (16).

11. The device according to claim 10, characterized in that the hydrocarbon sensor is arranged behind a diesel particle filter (DPF) which is connected downstream of the nitrogen oxide catalytic converter.

12. The method according to claim 1, characterized in that the hydrocarbon concentration which passes through is determined per pulse.

13. The method according to claim 2, characterized in that the predefined limiting value is predefined as a function of the catalytic converter temperature.

14. The method according to claim 1, characterized in that the hydrocarbon concentration which passes through is averaged over time over a plurality of pulses.

15. The method according to claim 2, characterized in that the predefined limiting value is predefined as a function of the exhaust gas mass flow.
